(19) United States
(12) Patent Application Publication
(10) Pub. No.: US 2008/0041060 A1
(43) Pub. Date: Feb. 21, 2008

(54) Fuel injector for a gas turbine engine

(75) Inventors: Ulf Nilsson, Whetstone (GB); Nigel Wilbraham, Stourbridge (GB)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/893,511

(22) Filed: Aug. 16, 2007

(30) Foreign Application Priority Data
Aug. 16, 2006 (EP) 06017043.8

(51) Int. Cl. F02M 41/00

(52) U.S. Cl. 60/737; 60/742

(57) ABSTRACT

Disclosed is a ring-shaped fuel injector having an inner diameter, an outer diameter and a height, a fuel groove arranged in a face side of the ring, and at least one fuel injection opening arranged on the ring and connected to the fuel groove.

### FIELD OF THE INVENTION

The invention relates to a fuel injector and a burner suitable for simple manufacturing as well as further diminishing air pollutants such as nitrogen oxides (Noₓ).

### BACKGROUND OF THE INVENTION

In the field of gas turbine combustors it is well known that multiple fuel streams and conventional conduits can cause mechanical complexity, long assembly and service times and the probability of occasional leaks. In addition, where several fuel streams are present in a combustor, space problems may also arise. Furthermore, the length and fluid resistance of such passages can require extra fuel compression due to additional fuel pressure losses which constrain the design and performance of burner mixing passages. By simplifying complex manufacturing processes, operational performance is enhanced.

Environmentally sound operation is another concern and many countries have strict laws limiting the emission of the pollutants from gas turbine engines. One method for reducing the emission of pollutants is thorough mixing of fuel and air prior to combustion thereby avoiding high temperature stoichiometric fuel air mixtures in the combustor. Hence the temperature dependent formation rate of oxides of nitrogen is lowered. Although the prior techniques for reducing the emissions of nitrogen oxides from gas turbine engines are steps in the right direction, the need for additional improvements remains.

There are two main measures by which reduction of the temperature of the combustion flame is achievable. The first is to use a low fuel/air ratio as a result of a well distributed fuel injection. The thermal mass of the air present in the reaction zone of a lean premixed combustor absorbs heat and reduces the temperature rise of the products of combustion to a level where thermal NOₓ is kept low. The second measure is to provide a thorough mixing of fuel and air prior to combustion. The better the mixing, the smaller the volumes where the fuel/air mixture is significantly richer than average, therefore the volume fraction reaching higher temperatures than the average will be small, hence less thermal NOₓ will be formed.

Usually the premixing takes place by injecting fuel into an air stream in a swirling zone of a combustor which is located upstream from the combustion zone. The swirling flow leads to a mixing of fuel and air before the mixture enters the combustion zone.

EP 0 722 065 A2 describes a fuel injector arrangement for a gas- or liquid-fuelled turbine. The injection ports are axial relative to a central axis of the swirler.

EP 0 957 311 A2 describes a gas turbine engine combustor with axial fuel injectors relative to the central axis of the swirler and pilot fuel injectors at an orientation where the fuel is injected substantially tangentially into the swirler.

U.S. Pat. No. 5,765,366 describes an integrated ring shaped fuel conduit supplying all burners in an annular combustion chamber. Two distribution bores arranged in the rear wall of the burner hood for each burner connect to the main gas ring line and the pilot gas ring line respectively.

### SUMMARY OF THE INVENTION

An object of the invention is to provide a new fuel injector to firstly accomplish simplified manufacturing of otherwise complex passages, secondly enable easy access for cleaning, exchanging or modifying the fuel injector as required for specific applications, and thirdly allow for a better control of the pre-mixing of gaseous fuel and air to provide a homogeneous or predetermined fuel/air mixture for reduced formation of NOₓ.

This objective is achieved by the claims. The dependent claims describe advantageous developments and modifications of the invention.

An inventive fuel injector comprises a ring, a fuel groove arranged in a face side of the ring, and fuel injection openings arranged on the ring and connected to the fuel groove.

By such a design of the fuel injector a simplified manufacturing of complex passages is achieved. The flexible design allows for easy disassembly of the fuel injector for cleaning or reconfiguration of the swirler fuel injection geometry. The easier and the more accurate an injection system of a swirler can be adapted to the operation conditions like fuel type, load, or combustor driven pressure oscillations the lower the formation of NOₓ.

Swirler vanes are arranged about a central axis. Swirler passages are formed between the swirler vanes. A ring-shaped fuel injector is arranged directly upstream of the swirler vanes relative to the flow of hot gases and forming steps at the entries of the swirler passages. Air vortices are created at these steps when compressor air enters the swirler passages. These vortices improve the mixing of compressor air and fuel injected through the fuel injection openings on the fuel injector, and a controlled distribution of the fuel/air mixture for improved NOₓ emissions is achieved. The fuel injection openings are cut backs in the side face of the ring where the fuel groove is arranged or machined holes. Advantageously a fuel injection opening is provided with a recess or chamfer.

It is particularly advantageous when notches, surrounding the fuel groove and/or being surrounded by the fuel groove, are arranged in the face side of the fuel injector and corresponding notches are arranged on the plate where the fuel injector is fixed on to cover the fuel groove. The plate can be a back plate that is arranged on the injector especially for this purpose or a swirler base plate. The cavities formed by the notches carry sealing elements for providing a seal between the back plate or swirler base plate and the fuel injector.

In a further advantageous embodiment keys are arranged on the ring extending into swirler passages. Since different fuels have different ignition characteristics depending on the concentration of H₂ and CO it can be advantageous to decrease the time spent by the fuel in the burner. This is achieved by protruding keys having injection openings.

In a particular realisation vortex producing cut-outs with a triangular cross-section are arranged on the ring or on the keys. Fuel injection openings are arranged in the remaining triangular solid portions between the cut-outs.

In a particular realisation protruding keys are arranged as stepped keys where fuel injection openings are arranged on more than one step of the key. It is advantageous to have one more step than rows with fuel injection openings on a stepped key to benefit from an upper and a lower vortex.

In a further advantageous embodiment the step heights and the area of the fuel openings are tailored to achieve an improved fuel distribution in the swirler passage. Further improvements can be realized when two adjoining steps are not parallel but cut at an angle to allow the vortices to separate from the edges at a different position in the main flow di-reaction.

In a particular realisation the fuel is not only injected on only one side, like the inner, the outer, or the face side of the fuel injector. The fuel is injected at the same time on different sides of the fuel injector. Furthermore it is not mandatory that the direction of fuel injection lies in the plane containing the axis of symmetry of the fuel injector. It also does not need to be parallel to the swirler vane side faces at the upstream end of the swirler passages.

In a particular embodiment of the fuel injector the height and/or cross-sectional area of the fuel injection opening closest to a sharp edge of a compressor air inlet is the largest. The height and/or cross-sectional area of fuel injection openings decrease relative to a distance to a sharp edge of the compressor air inlet opening. Flow from an opening with the larger cross sectional area has a higher mass flow and will therefore assist in biasing the fuel distribution along the swirler passage. By changing the fuel injection opening number and sizes, the fuel distribution pattern along the swirler passage can be controlled. This may also be adjusted by changing the step height. Combustion driven pressure oscillations and emissions can be influenced by controlling these parameters.

In another embodiment the fuel injector 12 comprises fuel injection openings 16, 17 and the fuel groove 14 is arranged in the swirler base plate 20.

In an alternative arrangement where the swirler vanes 21 are directly attached to the burner head 1, the fuel injector 12 comprises fuel injection openings 16, 17. The fuel groove 14 is arranged in the burner head 1.

### BRIEF DESCRIPTION OF THE DRAWINGS

The invention will now be further described, by way of example, with reference to the accompanying drawings in which:

FIG. 1 shows a longitudinal section through a combustor,

FIG. 2 shows a perspective view of the inventive fuel injector,

FIG. 3 is a top view representation of two embodiments of the inventive fuel injector with axial injection installed in an axial swirler,

FIG. 4 is a side view representation of two embodiments of the inventive fuel injector with axial injection installed in an axial swirler,

FIG. 5 is a top view representation of two embodiments of the inventive fuel injector with radial injection installed in an axial swirler,

FIG. 6 is a side view representation of two embodiments of the inventive fuel injector with radial injection installed in an axial swirler,

FIG. 7 is a side view representation of an embodiment of the inventive fuel injector with radial injection installed in a radial swirler,

FIG. 8 shows a perspective view of the inventive fuel injector and swirler vanes arranged on a swirler base plate of a radial swirler,

FIG. 9 shows a swirler vane and a partial section of the fuel injector with a protruding key having a straight step,

FIG. 10 shows a swirler vane and a partial section of the fuel injector with a protruding stepped key,

FIG. 11 shows a swirler vane and a partial section of the fuel injector with a protruding key having an angled or curved step,

FIG. 12 shows a swirler vane and a partial section of the fuel injector with a protruding key having a varying step height,

FIG. 13 shows a swirler vane and a partial section of the fuel injector with a protruding key having a double-angled step,

FIG. 14 shows a swirler vane and a partial section of the fuel injector with a protruding-key having a double-angled step with a varying step height,

FIG. 15 shows a perspective view of straight cut-outs in the fuel injector,

FIG. 16 shows a top view of straight cut-outs in the fuel injector,

FIG. 17 shows a perspective view of triangular cuts in the fuel injector, and

FIG. 18 shows a top view of triangular cut-outs in the fuel injector.

In the drawings like references identify like or equivalent parts.

### DETAILED DESCRIPTION OF THE INVENTION

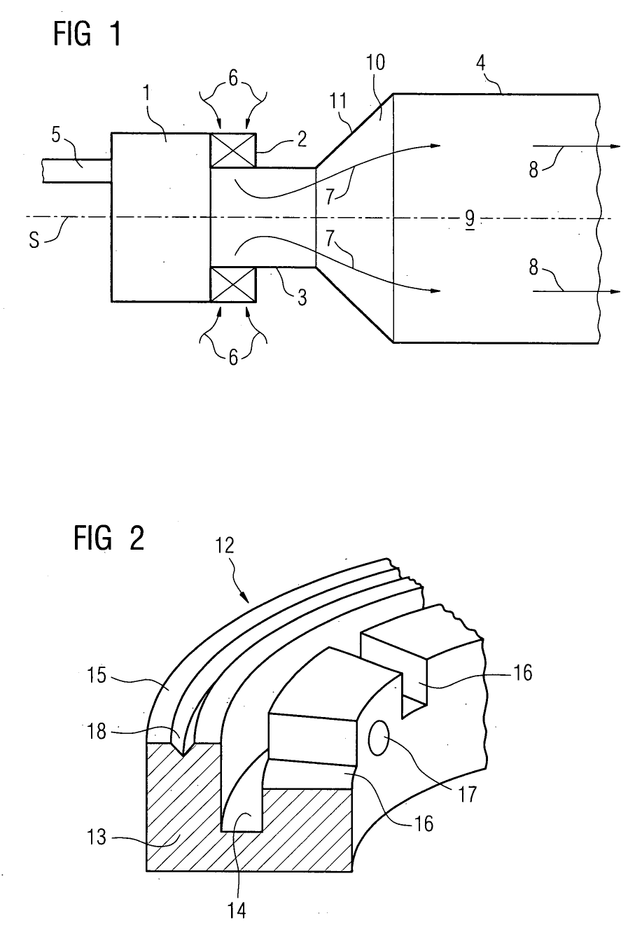

FIG. 1 shows a longitudinal section through a combustor. The combustor comprises relative to a flow direction: a burner with swirler portion 2 and a burner-head portion 1 attached to the swirler portion 2, a transition piece referred to as combustion pre-chamber 3 and a main combustion chamber 4. The main combustion chamber 4 has a diameter being larger than the diameter of the pre-chamber 3. The main combustion chamber 4 is connected to the pre-chamber 3 via a dome portion 10 comprising a dome plate 11. In general, the transition piece 3 may be implemented as a one part continuation of the burner 1 towards the combustion chamber 4, as a one part continuation of the combustion chamber 4 towards the burner 1, or as a separate part between the burner 1 and the combustion chamber 4. The burner and the combustion chamber assembly show rotational symmetry about a longitudinally symmetry axis S.

A fuel conduit 5 is provided for leading fuel to the burner which is to be mixed with in-streaming air in the swirler 2. The fuel/air mixture 7 is then guided towards the primary combustion zone 9 where it is burnt to form hot, pressurised exhaust gases streaming in a direction 8 indicated by arrows to a turbine of the gas turbine engine (not shown).

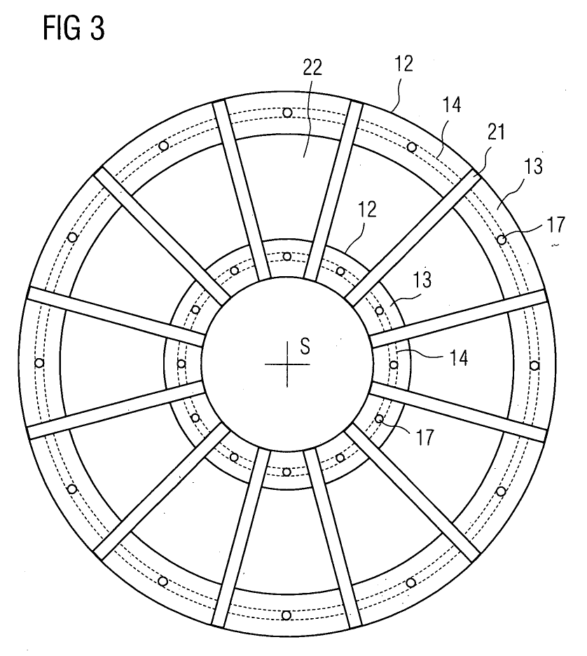

With reference to FIG. 2 a fuel injector 12 comprises a ring 13. A fuel groove 14 is arranged in a face side 15 of the ring 13. Fuel injection openings 16,17 are arranged on the ring 13 as cut-back type 16 and/or machined-hole type 17 and connected to the fuel groove 14. A first outer notch 18 is arranged in the face side 15 of the ring 13. The first outer notch surrounds the fuel groove.

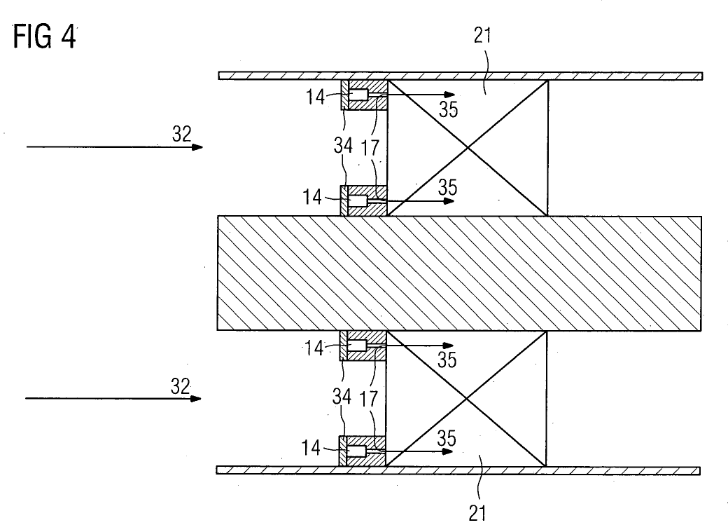

In an exemplary embodiment of the invention (FIGS. 3 and 4) two fuel injectors 12 of different size are fastened concentrically to an axial swirler. The fuel grooves 14 are covered by back plates 34 and the fuel injection openings 17 point in the direction of the symmetry axis of the fuel injectors 12. The instreaming air enters the swirler 19 between the two fuel injectors 12.

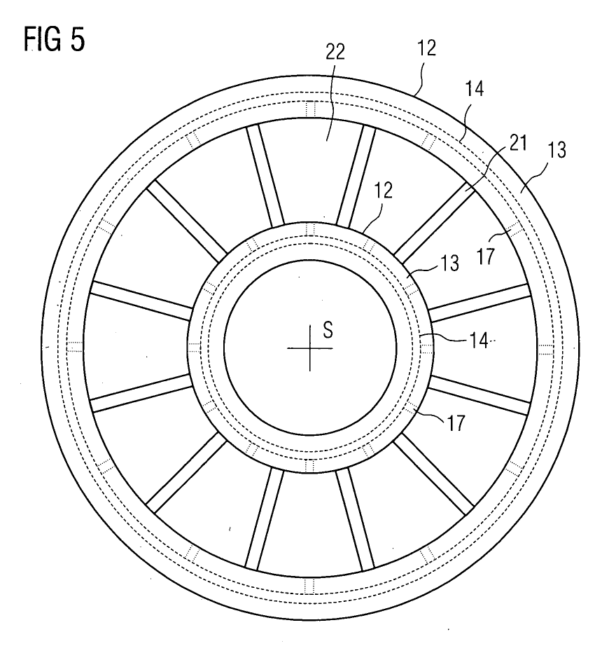

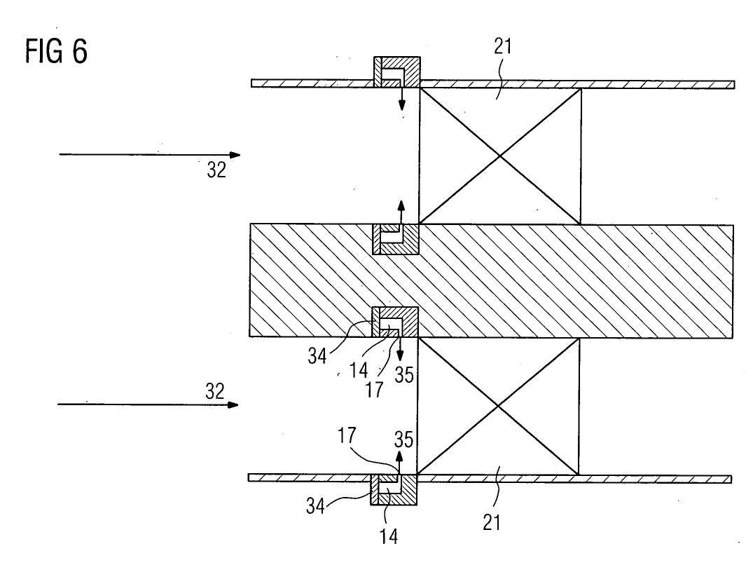

In another exemplary embodiment of the invention (FIGS. 5 and 6) two fuel injectors 12 are fastened concentrically to an axial swirler. The fuel grooves 14 are covered by back plates 34 and the fuel injection openings 17 are oriented in a radial direction. The fuel injection openings 16, 17 of the smaller fuel injector 12 point radially outwards and the fuel injection openings 16,17 of the larger fuel injector 12 point radially inwards.

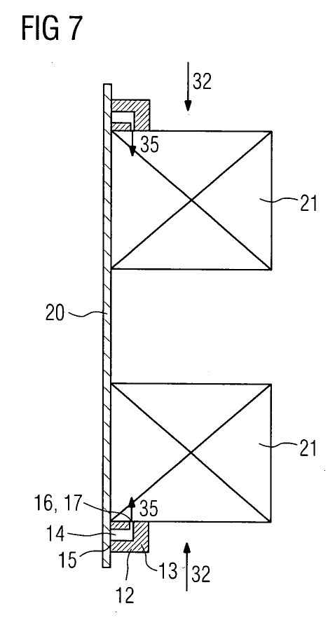

With reference to FIG. 7 a fuel injector 12 is attached to a swirler base plate 20. The swirler base plate 20 covers the fuel groove 14. Fuel injection openings 17 connect to the fuel groove 14 and inject fuel radially inwardly into swirler passages 22 where the fuel mixes with the instreaming compressor air 32.

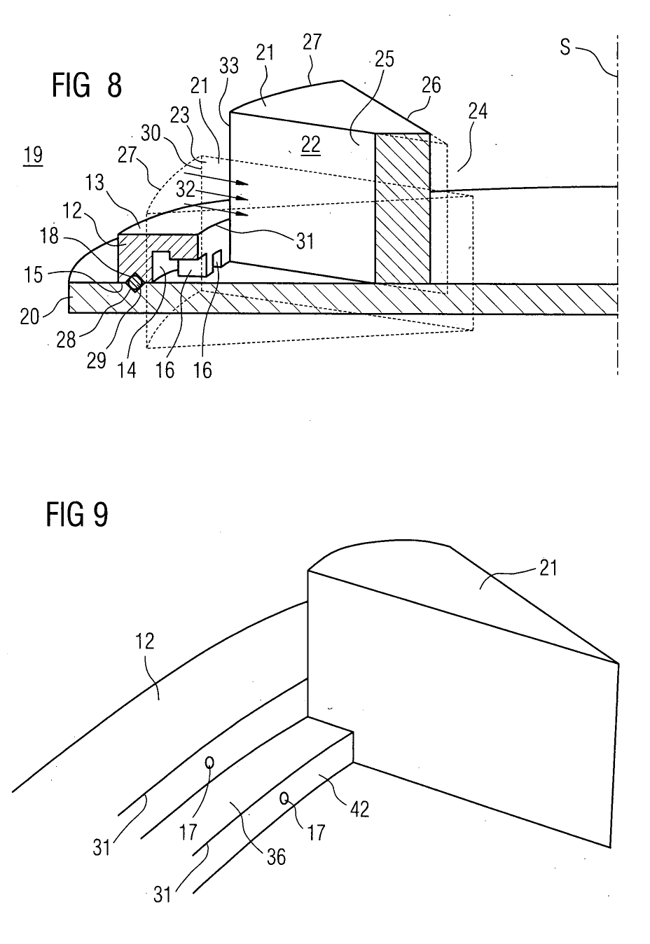

With reference to FIG. 8 a swirler 19 comprises a swirler base plate 20, a plurality of swirler vanes 21 arranged on the swirler base plate 20 about a central axis S. A plurality of swirler passages 22 extends from a compressor air inlet opening 23 to a mixture outlet opening 24, said swirler passages 22 formed by first and second side faces 25, 26 of the swirler vanes 21 and the swirler base plate 20. A fuel injector 12 is attached to the swirler base plate 20. The fuel injector 12 has the shape of a ring 13 with an inner diameter equal to the outer diameter of a circle formed by outer faces 27 of the swirler vanes. The height of the fuel injector 12 is smaller than a swirler vane 21 height. A fuel groove 14 arranged in a face side 15 of the fuel injector 12 is facing the swirler base plate 20. A first outer notch 18 is arranged in the face side 15 of the fuel injector 12 facing the swirler base plate 20. A second outer notch 28, facing the first outer notch 18, is arranged in the swirler base plate 20. First and second outer notches 18, 28 act as counterparts to form a cavity that carries a sealing element 29 for providing a seal between the swirler base plate 20 and the fuel injector 12. The sealing element 29 may be a crushable C-seal.

FIG. 8 further shows a cross-section through an embodiment with two fuel injection openings 16 facing a swirler passage 22, whereby the cross-section projects through one of the openings 16. Some of the cut-away parts like a swirler vane 21 in the foreground and a tip of a neighbouring swirler vane 21 arranged behind are shown with dashed lines.

The swirler vane tips do not point to the central axis S but are turned to one side giving rise to different lengths of first and second side faces 25, 26 of swirler vanes 21—the first side face 25 is shorter than the second side face 26 as well as sharp and obtuse edges 30, 33 at the compressor air inlet opening 23. The height and/or cross-sectional area of the fuel injection opening 16 closest to a sharp edge 30 is the largest. Height and/or cross-sectional area of fuel injection openings 16 decrease relative to a distance to a sharp edge 30 of the compressor air inlet opening 23.

With reference to FIG. 9 keys 42 can be arranged on the fuel injector 12 extending into swirler passages 22. In a simple embodiment a key 42 is forming a straight step 31 parallel to the ring contour.

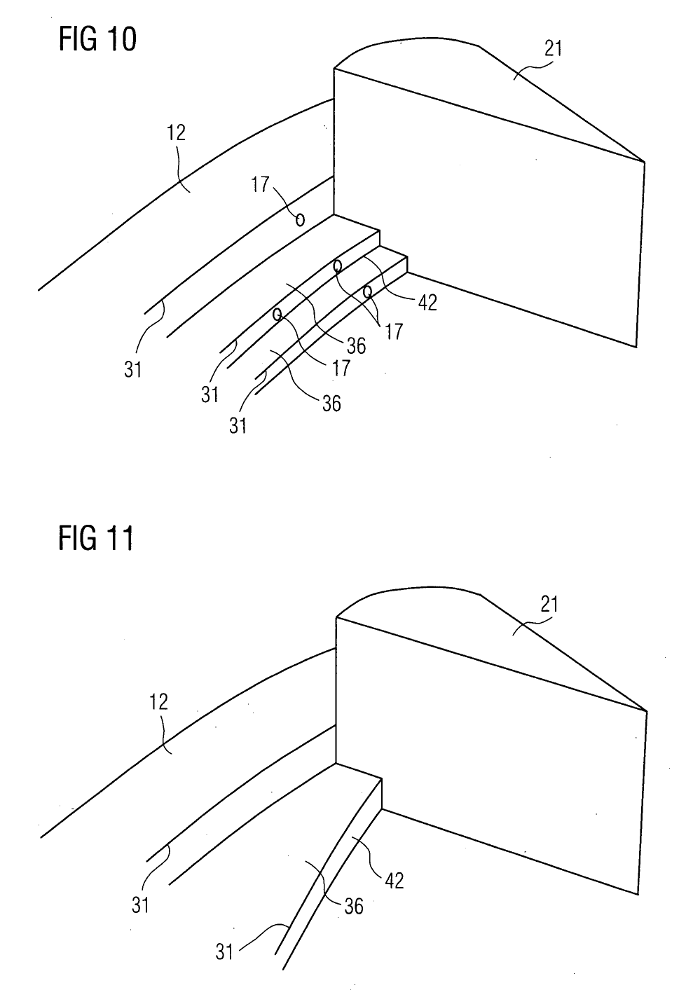

With reference to FIG. 10 keys 42 can be stepped.

With reference to FIG. 11 the protruding key 42 is angled or curved relative to the fuel injector ring 13 forming a winder-like tread 36.

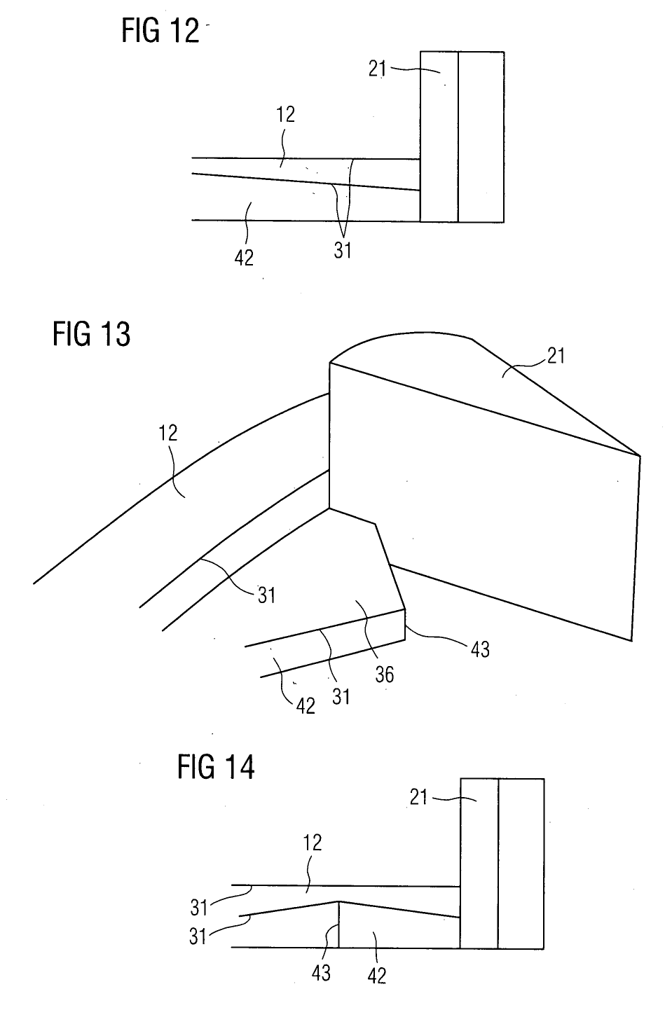

With reference to FIG. 12 the tread 36 of the step 31 formed by the protruding key 42 is not parallel to the face side 15 of the fuel injector 12 but tilted or curved.

With reference to FIG. 13 the tread 36 of the step 31 formed by the protruding key 42 has an angle 43.

With reference to FIG. 14 the step 31 formed by the protruding key 42 has a maximum height at the step angle 43.

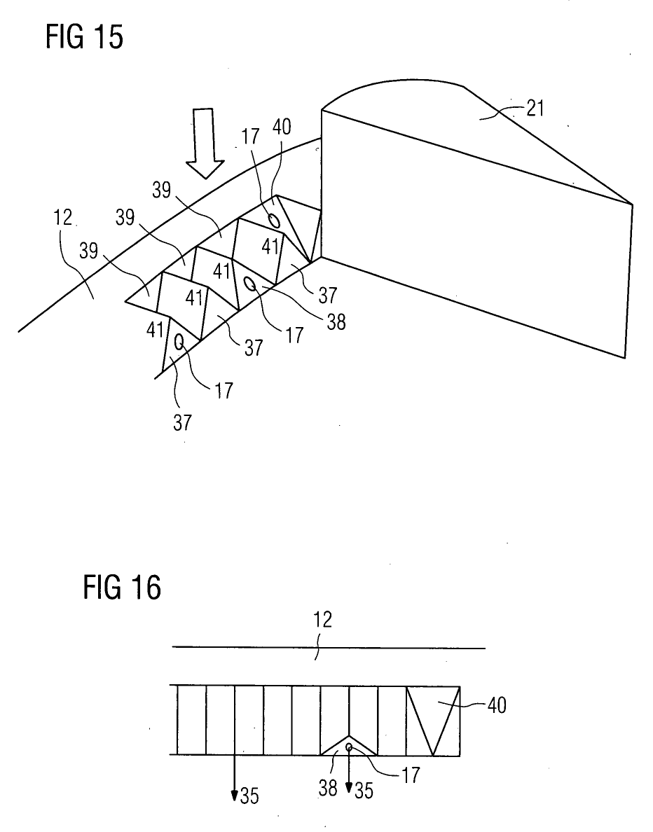

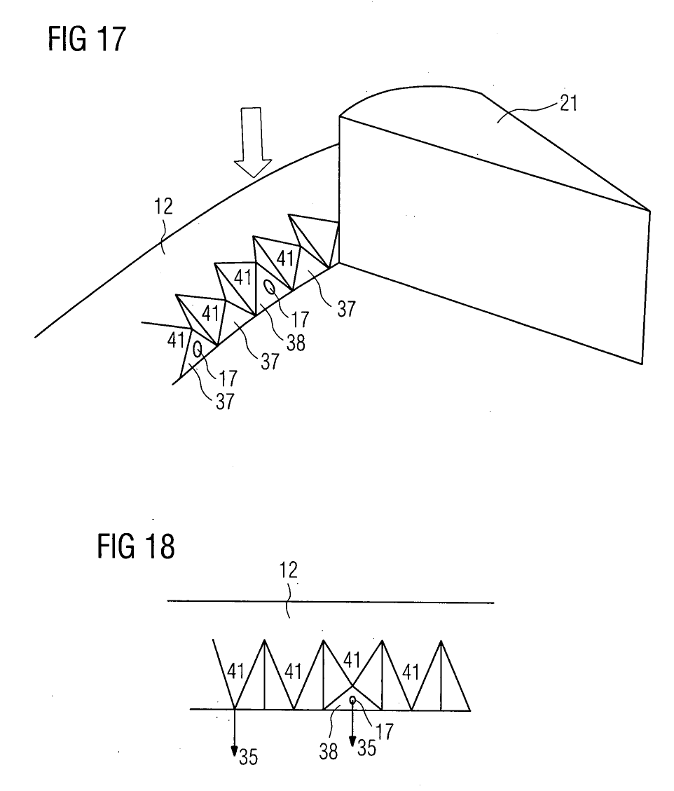

With reference to FIGS. 15, 16, 17, and 18 cut-outs with triangular cross-sections are arranged on the ring 13 of the fuel injector 12 turned away from the instreaming air 32. FIG. 16 shows a top view of FIG. 15 in the direction indicated by the arrow. The cut-outs in the FIGS. 15 and 16 are straight. The front faces are upright 37 or inclined 38 as well as the rear faces that are either upright 39 or inclined 40. Fuel openings 17 are arranged on the remaining triangular solid portions 41 between the cut-outs and on the rear faces 39, 40 of the cut-outs. The preferred rear face is an inclined rear face 40, shown in FIG. 15. The cut-outs shown in FIGS. 17 and 18 are triangular. FIG. 18 shows a top view of FIG. 17 in the direction indicated by the arrow. Again, the front faces are upright 37 or inclined 38.

1.-17. (canceled)

18. A fuel injector, comprising:
a ring having an inner diameter, an outer diameter and a height;
a fuel groove arranged in a face side of the ring; and
a fuel injection opening arranged on the ring and connected to the fuel groove.

19. The fuel injector as claimed in claim 18, further comprising a first outer notch arranged in the face side and surrounding the fuel groove.

20. The fuel injector as claimed in claim 19, further comprising a first inner notch arranged in the face side and surrounded by the fuel groove.

21. The fuel injector as claimed in claim 18, further comprising a key arranged on the ring forming a step.

22. The fuel injector as claimed in claim 21, wherein the step is parallel to the ring contour and has a constant tread depth.

23. The fuel injector as claimed in claim 21, wherein the step has a winder-like changing tread depth.

24. The fuel injector as claimed in claim 21, wherein the tread is tilted around a radial axis of the ring.

25. The fuel injector as claimed in claim 21, wherein the tread has at least one angle.

26. The fuel injector as claimed in claim 25, wherein the step has a minimum or maximum step height measured at the at least one angle.

27. The fuel injector as claimed in claim 21, wherein at least one cut-out is arranged in the ring or in the step either in axial or radial direction relative to the axis of rotational symmetry of the ring and the cut-out has a triangular cross-section.

28. The fuel injector as claimed in claim 21, wherein the key is a stepped key.

29. The fuel injector as claimed in claim 21, wherein the fuel injection opening connected to the fuel groove is arranged on at least one step of at least one key.

30. A burner, comprising:
a plurality of swirler vanes arranged about a central axis, wherein each individual swirler vane has a first side face and a second side face;
a plurality of swirler passages extending from a compressor air inlet opening to a mixture outlet opening, wherein the plurality of swirler passages are formed by first and second side faces of adjacent swirler vanes;
a fuel injector arranged directly upstream of the swirler relative to the flow direction of hot gases, the fuel injector comprising:
a ring having an inner diameter, an outer diameter and a height;
a fuel groove arranged in a face side of the fuel injector and facing the swirler base plate or the fuel groove arranged in a swirler base plate or in a back plate facing the fuel injector; and
a fuel injection opening arranged on the ring and connected to the fuel groove and facing a swirler passage.

31. The burner as claimed in claim 30, further comprising a first outer notch arranged in the face side of the fuel injector and surrounding the fuel groove.

32. The burner as claimed in claim 31, further comprising:
a second outer notch facing the first outer notch and arranged in the swirler base plate or injector back plate; and
a cavity formed by the first and second outer notches carrying a sealing element for providing a seal between the swirler base plate or back plate and the fuel injector.

33. The burner as claimed in claim 32, wherein the cross-sectional areas of a plurality of injection openings facing the same swirler passage decrease relative to a distance to a sharp edge of the compressor air inlet opening, the sharp edge formed by at least one of the swirler vanes, wherein the first side face is shorter than the second side face of the respective swirler vane.

34. The burner as claimed in claim 33, wherein a key is arranged on the ring and extends into a swirler passage.
